(19) United States
(12) Patent Application Publication
(10) Pub. No.: US 2011/0175726 A1
(43) Pub. Date: Jul. 21, 2011

(54) Wireless Distress System

(76) Inventors: John Baird, Charlottesville, VA (US); Roma David Radford, JR., Prince George, VA (US)

(21) Appl. No.: 12/690,443

(22) Filed: Jan. 20, 2010

(51) Int. Cl. G08B 1/08

(52) U.S. Cl. 340/539.21; 340/539.16

(57) ABSTRACT

A wireless distress system and method compares signals transmitted from fixed wireless devices to more accurately determine the location of a mobile wireless distress device. The system and method may compare the signal pattern of a mobile wireless device to the signal patterns of fixed wireless devices in known locations. The location of a fixed wireless device with a signal pattern that most closely matches the signal pattern of the mobile wireless device may be used as the location of the mobile wireless distress device.

### BACKGROUND OF THE INVENTION

The invention relates in general to a system and method for locating people or objects, and more particularly, to a system and method for locating a mobile wireless distress device.

Historically, location information in distress systems has been very coarse, with difficulty determining more than a general location. In a building, wireless signals tend to bounce and reflect off objects in the building, making direct computation of the location difficult.

### SUMMARY OF THE INVENTION

This invention relates to a wireless distress system and method that compares signals transmitted from fixed wireless devices to more accurately determine the location of a mobile wireless distress device. The system and method may compare the signal pattern of a mobile wireless device to the signal patterns of fixed wireless devices in known locations. The location of a fixed wireless device with a signal pattern that most closely matches the signal pattern of the mobile wireless device may be used as the location of the mobile wireless distress device.

Various advantages of this invention will become apparent to those skilled in the art from the following detailed description of the preferred embodiment, when read in light of the accompanying drawings.

### BRIEF DESCRIPTION OF THE DRAWINGS

FIG. 1 is a diagrammatic representation of a wireless system.

FIG. 2 is a partial top plan view of a system environment.

FIGS. 3A and 3B are schematic representations of repeater arrangements.

FIG. 4 is a diagrammatic representation of signal transmissions.

FIGS. 5-8 are flow charts of methods for determining the location of a mobile wireless device.

### DETAILED DESCRIPTION OF THE PREFERRED EMBODIMENT

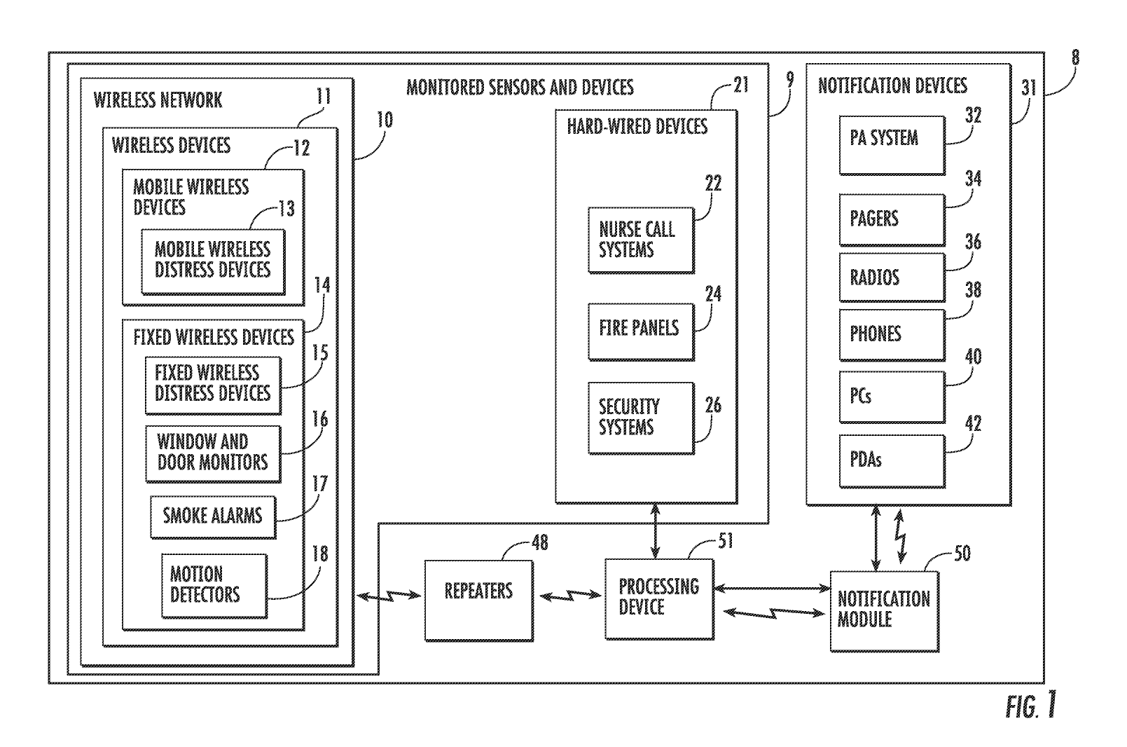

Referring now to the drawings, there is illustrated in FIG. 1 an exemplary wireless distress system, generally indicated at 8. The system may integrate an array of monitored sensors and devices 9, which may be spaced apart, including a network 10 of wireless devices 11, such as mobile wireless devices 12, including one or more first or mobile wireless distress transmitters or devices 13 (e.g., transmitters or pendants), and fixed wireless devices 14, including one or more second fixed wireless distress transmitters or devices 15 (e.g., pull cords), door and window monitors 16, smoke alarms 18, and motion detectors 20, as well as hard-wired devices 21, including nurse call systems 22, fire panels 24, and security systems 26. The system 8 may send voice, email, and text alerts to notification devices 31, such as a PA system 32, pagers 34, radios 36 (e.g., two-way radios), telephones 38 (mobile and landlines), PCs 40, and PDAs 42, to notify staff members or attendants of alerts (e.g., alert messages) from the monitored sensors and devices 9, which allows the attendants to respond to the alerts.

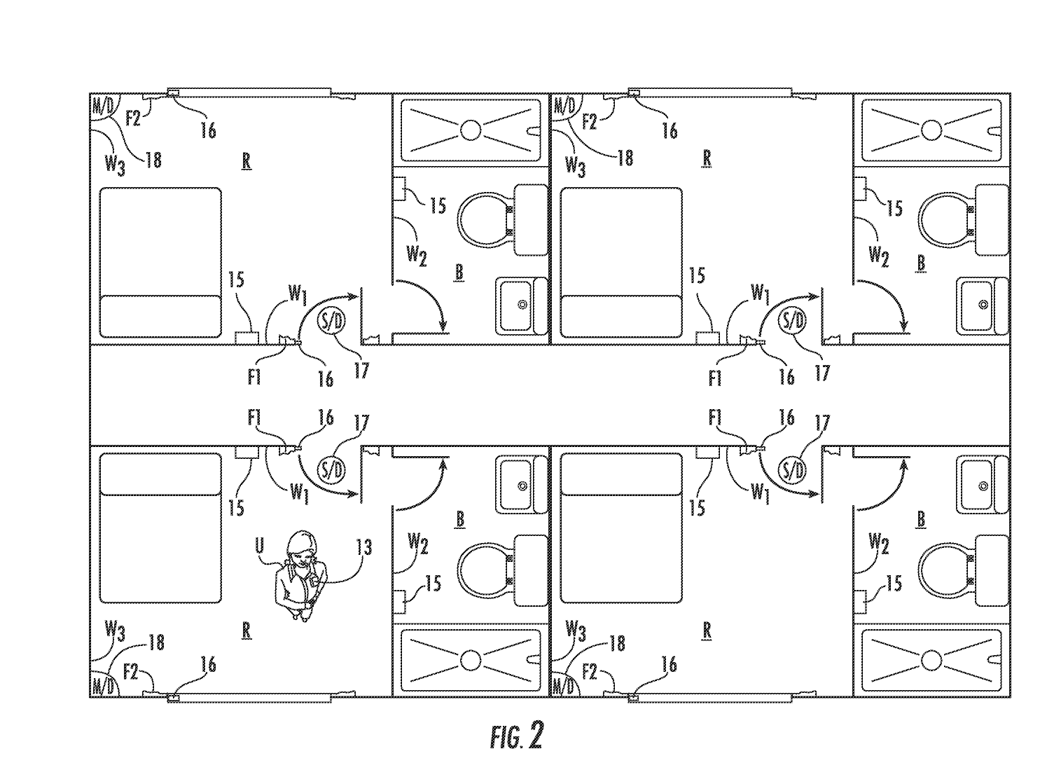

As depicted in FIG. 2, mobile wireless distress devices 13 may be worn by a user U, for example, on a necklace, clipped to the user's belt, or worn around the user's wrist. Fixed wireless devices 14 may be mounted in any suitable fixed location. For example, fixed wireless distress devices 15 may be mounted on a wall W1, W2 near the bed in a patient's room R or in an adjoining bathroom B, door and window monitors 16 may be mounted on door and window frames F1, F2, smoke detectors 18 may be mounted on the ceiling, and motion detectors may be mounted on a wall W3. The wireless devices 11 may be versatile and adapted to a wide range of installations. The devices 11 may have an operating frequency in the order of 902-928 MHz, or another suitable operating frequency.

Referring back to FIG. 1, the system 8 may include repeaters 48 (e.g., high powered receivers), which may amplify transmission signals from any wireless device 11, and which may be capable of ignoring background noise. The repeaters 48 may receive and re-transmit or relay transmissions to dramatically expand the range of the wireless devices 11.

The repeaters 48 may be suitable for large environments, such as multi-floor buildings, multi-building sites, shopping malls, campuses, and other open-air installations. The repeaters 48 may include an onboard backup battery. It should be appreciated that virtually any number of repeaters 48 may be added to the system 8, scaling the size of the system 8 as needed. For applications that require protection from environmental elements, an outdoor weatherproof enclosure may be used.

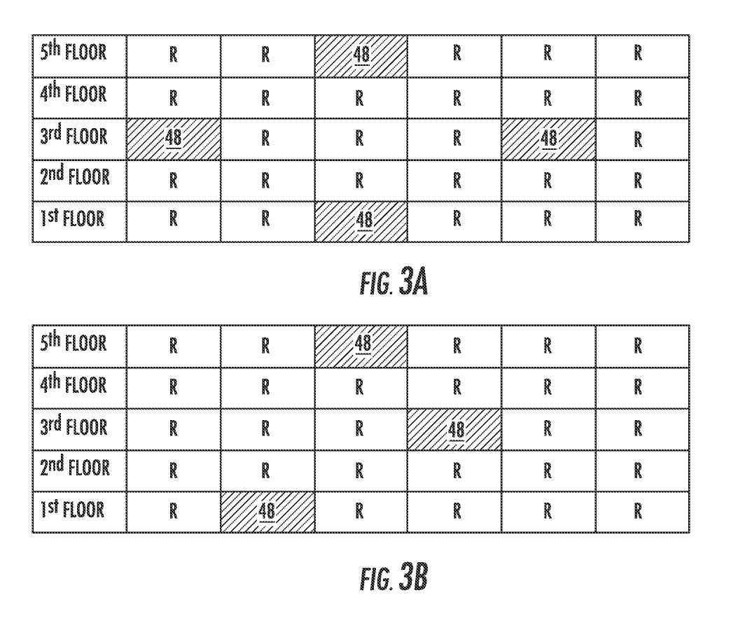

The repeaters 48 may be positioned in any suitable location, and may be most suitably positioned so that a transmission signals from any wireless device 11 may be picked up by two or more repeaters 48, although other positions may be suitable. It may be desirable to avoid stacking repeaters 48 in the center of the environment, unless repeaters 48 are provided on either side of the stack, as depicted in FIGS. 3A and 3B, to differentiate the origin of the signal and the location of the device 14, as will become more apparent in the description that follows. Once repeaters 48 are positioned, a coverage test may be performed in any suitable manner to verify that the environment is sufficiently covered.

Again, referring to FIG. 1, the system 8 may further work in conjunction with a notification module 50 to deliver the alerts. The module 50 may be a monitoring and rules-based module that leverages paging and dial out capability. The module 50 may be responsive to monitored sensors and devices 9 to deliver alerts to notification devices 31.

The system 8 may include a processing device 51, such as a computer, or other suitable device, which may be centrally located, and which may function as control unit and an arithmetic/logic unit, and which may include memory, together with software, input/output devices, and other suitable hardware and/or hardware modules. The computer may be capable of multitasking, multiprocessing, networking, and accessing the Internet. The processing device 51 may process signals relayed from the repeaters 48 and in response, communicate with the notification module 50 to cause the notification module 50 to deliver the alerts, as will become more apparent in the description that follows.

Each wireless device 11 may have wireless signal characteristics that may be determined by the origin of the signal of the device 11. For example, when a wireless device 11 is activated, the signal of the device 11 may bounce and reflect off objects in route to the repeaters 48, depending on the origin of the signal and location of the device 11. This may affect the strength of the signal of each device 11, resulting in a signal patterns relayed from the repeaters 48. The signal pattern provides information about the origin of the signal and the location of the device 11. As a result, the signal transmitted by each wireless device 11 may be unique to the location of the device 11, resulting in a unique wireless signal characteristic for each device 11.

The location of each fixed wireless devices 14 may be determined. This may be done in any suitable manner. For example, each device 14 may transmit a signal with an identifying characteristic, such as a signature or other identifying characteristic carried by the signal, which is unique to the device 14 and thus allows the device 14 to be identified. Alternatively, each fixed wireless device 14 may be individually or separately activated from its fixed location to transmit a signal, exclusive of other devices 14. As the devices 14 are separately activated, the location of each device 14 may be stored, recorded, plotted, mapped, or otherwise retained by the system 8, for example, on processing device 51.

Knowing the location each fixed wireless device 14, the wireless signal characteristics of each device 14 may be associated with each device 14. This may be accomplished by activating each device 14 individually or separately to produce a signal from each device 14. The location of each device 14, together with its wireless signal characteristics, may be stored so that the system 8 may associate the wireless signal characteristics with the location of the device 14.

Some locations in the environment may not include fixed wireless devices 14. It should be appreciated that mobile wireless devices 12 may be activated in locations in the environment that are not covered by fixed wireless devices 14. Wireless signal characteristics of these devices 12 may be stored so that the system 8 may associate a wireless signal characteristic with that location.

It should be appreciated that the location information of each fixed wireless device 14 may include of a name or description of the device 14. For example, if the environment has numbered rooms, then the location information might result in a message, such as “100,” “101,” “102,” and so on, associated with the rooms. If the environment has numbered rooms with multiple devices 14, then the location information might result in a message, such as “100 Bed,” “100 Bath,” “101 Bed,” and so on.

The system may be set up in any suitable manner. For example, repeaters 48 may be installed and initial coverage test may be performed. Wireless signal characteristics (i.e., signal patterns) of fixed wireless devices 14 (e.g., fixed wireless distress devices 15, window or door monitors 16, smoke detector 18, motion detector 20, etc.) may be loaded into the system 8. Mobile wireless devices 12 may be activated in locations in the environment that are not covered by fixed wireless devices 14. System parameters may be modified as desired. A supplemental coverage test may be performed.

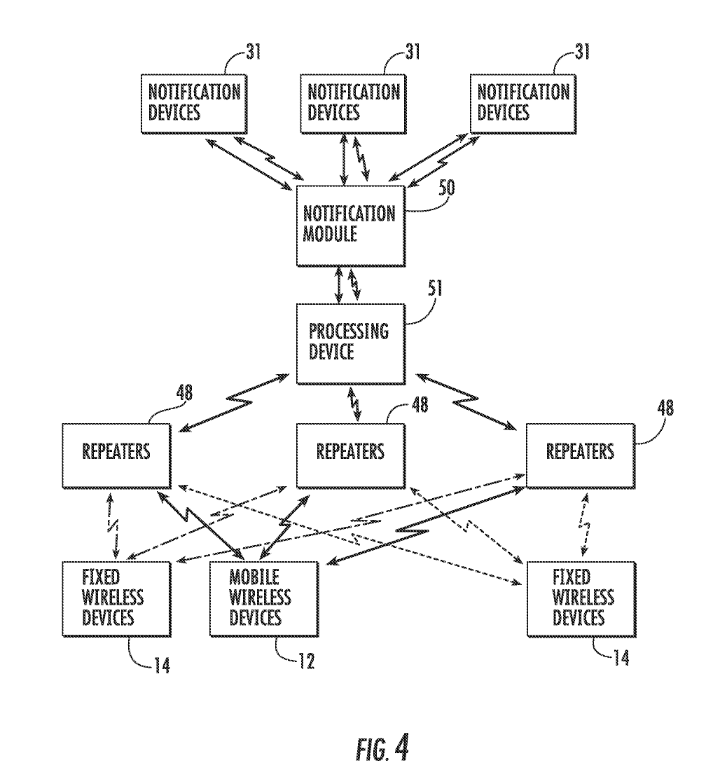

When a mobile wireless device, such as a mobile wireless distress device 13, is activated, the wireless signal characteristics provide information about the location of the device 13. For example, the signal of the device 13 may be received and relayed by multiple repeaters 48, as shown in FIG. 4. The resulting signal patterns of the device 13 relayed by each repeater 48 may provide information about the location of the device 13. The system 8 may compare the patterns of the mobile wireless distress device 13 to the patterns of fixed wireless devices 14 in known locations. The patterns of the mobile wireless distress device 13 can be compared to the patterns of fixed wireless devices 14 as follows.

The sequence of signal strengths may be treated as or represented by a vector V, where n may be the number of repeaters 48. Vectors V may correspond to the location of the corresponding wireless devices 11. For every fixed wireless device 14 in the system 8, a vector is stored representing the average signal strength of the device 14. When a mobile wireless distress device 13 is activated, the standard Euclidean distance algorithm may be used to compare the vector of the mobile wireless distress device 13 with the vector V of every other device (e.g., the fixed wireless devices 14) in the system 8. The location of a number of the closest fixed wireless devices 14 may be used as the location of the mobile wireless distress device 13. This may be better understood in the description that follows.

In a plane, a point may be uniquely specified by coordinates, which may be written as an ordered pair (x, y), such as (1, 5) or (3, 2). A vector V in space may also be represented by coordinates (x, y), with the usual operations of point-wise addition and scalar multiplication.

A vector V may be considered as a direction and a magnitude. For the point (x, y), a vector V may be visualized as a directed arrow, starting at an origin (0, 0) and ending at the point (x, y). The magnitude M of the vector V may be determined by the following equation.

M=sqrt(x²+y²) Eq. 1

The direction of the vector V may be the angle between the array and the x-axis. The vector V may be scaled so that magnitude M of the vector V is 1. This may be accomplished by dividing each coordinate by the total magnitude M of the vector V. The corresponding vector V of length 1 may be given by the following equation.

V=(x/M,y/M)=(x/sqrt(x²+y²),y/sqrt(x²+y²)) Eq. 2

The system 8 may normalize vectors V to length of 1 to account for a disparity in signal strengths in the mobile wireless distress device 13 and fixed wireless devices 14, in the event that the fixed wireless devices 14 have stronger signals than the mobile wireless distress device 13.

Given two points (x₁, y₁) and (x₂, y₂) in a plane, the distance between the two points may be calculated. The distance may be expressed by the Euclidean distance formula, as follows.

D=sqrt((x₁−y₁)²+(x₂−y₂)²) Eq. 3

The calculations of vectors V of length 1 and the distance formula may both extend to an n-dimensional (i.e., multi-dimensional) space, as expressed in the following series of equations.

x=(x₁,x₂, . . . ,xₙ) Eq. 4

M=sqrt(x₁²+x₂²+ . . . +xₙ²) Eq. 5

x/M=(x₁/M,x₂/M, . . . ,xₙ/M) Eq. 6

D=distance(x,y)=sqrt((x₁−y₁)²+(x₂−y₂)²+ . . . +(xₙ−yₙ)²) Eq. 7

In operation, the mobile wireless distress device 13 may be activated to transmit a signal, which is received by the repeaters 48 and relayed to the processing device 51, where the signal pattern is associated with a vector corresponding to the location of the mobile wireless distress device 13. The processing device 51 may compare the vector associated with the mobile wireless distress device 13 to vectors associated with the fixed wireless devices 14, which may be stored on the processing device 51, to determine the location of the mobile wireless distress device 13. The mobile wireless distress device 13 is located closest to the fixed wireless device 14 that transmits a signal associated with a vector that is closest in character (i.e., direction and optionally magnitude M) to the vector associated with the signal transmitted from the mobile wireless distress device 13. In response, the processing device 51 may communicate with the notification module 50 to cause the notification module 50 to deliver the alerts to attendants, which allows the attendants to respond to the alerts (e.g., bring aid to the user of the mobile wireless distress device 13.

An explanation of the system operation may be best understood, by example, as follows. The system 10 may have four repeaters 48, identified as “1,” “2,” “3,” and “4,” two fixed wireless devices 14, such as pull cords identified as “Pull-1” and “Pull-2”, and a mobile wireless distress device 13, such as a pendant identified as “Pendant.”

Transmissions of signals S_{Pull-1} and S_{Pull-2} may be received from the fixed wireless devices 14 (e.g., the two pull cords) with signal strengths, as indicated, for example, in Table 1 below.

TABLE 1
(Fixed Device Signal Strengths)

| Fixed Device | Repeater 1 | Repeater 2 | Repeater 3 | Repeater 4 |
|---|---|---|---|---|
| Pull-1 | 52 | 18 | 45 | No Signal |
| Pull-2 | No Signal | 34 | 45 | 57 |

The magnitudes M_{Pull-1} and M_{Pull-2} of the vectors V_{Pull-1} and V_{Pull-2} associated with the fixed wireless devices 14 may be determined based in the signal strengths of the devices 14. The magnitudes M_{Pull-1} and M_{Pull-2} may be normalized to a length of 1. As mentioned above, the normalization may aid in eliminating differences in the transmission power of the fixed devices 14 (which may have a larger battery and an antennae) and the mobile device 13.

As explained above with reference to Equation 5, the magnitudes M_{Pull-1} and M_{Pull-2} may be computed by taking the square root of the sum of the squares of the signal strengths, as expressed in the following equations.

M_{Pull-1}=sqrt(52²+18²+45²)=71.084 Eq. 8

M_{Pull-2}=sqrt(34²+45²+57²)=80.187 Eq. 9

After determining the magnitudes M_{Pull-1} and M_{Pull-2}, the distance of each fixed wireless device 14 from each repeater 48 may be determined by dividing the signal strength by the magnitude M_{Pull-1} and M_{Pull-2} of each device 14, using Equation 6 above. It should be noted that these distances should be between 0 and 1, as indicated, for example, in Table 2 below.

TABLE 2
(Fixed Device Distances)

| Repeater | Pull-1 | Pull-2 |
|---|---|---|
| 1 | 0.731529 | No Signal |
| 2 | 0.253222 | 0.424009 |
| 3 | 0.633054 | 0.561188 |
| 4 | No Signal | 0.710838 |

When the mobile wireless device 13 is activated (e.g., the pendant is depressed), a transmission of a signal S_{Pendant} from the device 13 may be received by the repeaters 48, with signal strengths, as indicated, for example, in Table 3 below.

TABLE 3
(Mobile Device Signal Strengths)

| Mobile Device | Repeater 1 | Repeater 2 | Repeater 3 | Repeater 4 |
|---|---|---|---|---|
| Pendant | 45 | 36 | 36 | 15 |

Using Equation 10 below, the vector magnitude M_{Pendant} for the mobile wireless device 13 may be determined.

M_{Pendant}=sqrt(45²+36²+36²+15²)=69.584 Eq. 10

The vector distance may be determined by dividing the signal strength by the magnitude M_{Pendant}, as indicated, for example, in Table 4 below:

TABLE 4
(Mobile Device Distance)

| Repeater | Pendant |
|---|---|
| 1 | 0.646700 |
| 2 | 0.517360 |
| 3 | 0.517360 |
| 4 | 0.215567 |

Now, the distance of the mobile wireless device 13 (e.g., the pendant) from each of fixed wireless device 14 (e.g., the pull cords) may be determined and compared. The location of the closest (e.g., the closest matching) fixed wireless device 14 may be used as the location of the mobile wireless distress device 13.

Since the environment is an n-dimensional space, n may represent the number of repeaters 48. The distance between two points on a line is simply the difference between the points. For example, if point x₁ is at position 2 and point x₂ is at position 5, the distance between the points (x₁, x₂) is 3. To extend that to n-dimensions, the distance is determined by taking the square root of the sum of the squares of the distances between the points, using the distances in Tables 3 and 4 above. In this example, the distances and differences are shown in Table 5 below.

TABLE 5
(Distances and Comparisons)

| | | | | Difference | Difference |
|---|---|---|---|---|---|
| Repeater | Pull-1 | Pull-2 | Pendant | 1 | 2 |
| 1 | 0.731529 | 0 | 0.646700 | 0.084829 | −0.646700 |
| 2 | 0.253222 | 0.424009 | 0.517360 | −0.264138 | −0.093351 |
| 3 | 0.633054 | 0.561188 | 0.517360 | 0.115694 | 0.043828 |
| 4 | 0 | 0.710838 | 0.215567 | −0.215567 | 0.495271 |

The difference in the distances between the fixed wireless device 14 identified as Pull-1 and the mobile wireless device 13 (e.g., the Pendant) is 0.369891 (i.e., the square root of the sum of the squares of the “Difference 1” column), and between the fixed wireless device 14 identified as Pull-2 and the mobile wireless device 13 is 0.821066 (i.e., the square root of the sum of the squares of the “Difference 2” column). The mobile wireless device 13 is closer to the device 14 identified as Pull-1 (i.e., approximately 0.37) than to device 14 identified as Pull-2 (i.e., approximately 0.82).

The location of the mobile wireless device (e.g., the pendant) could be reported as “Near Pull-1”. It should be understood that “Pull-1” could be identified as “101,” “Room 101,” “Apartment 101,” or some other suitable name. It should be appreciated that a plurality of locations could be reported, such as the top or three matches. It should be appreciated that the signal strengths are generally used to compute a point in space, then the distance is calculated from that point to all other points and the closest points are selected.

The system 8 may function as an automated alerting and awareness system that may send voice and text alerts via phone, pager, email, or other suitable devices to attendants. In addition to delivering alerts, the system may log triggering events in a database (e.g., associated with the processing device 51) and retain a record of the alerts for reporting and management purposes.

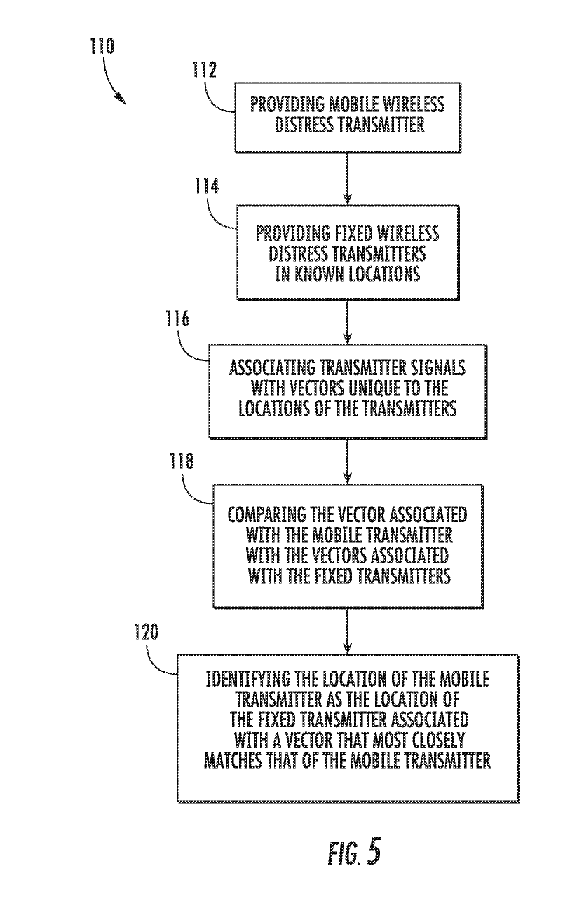

Now, with reference to FIG. 5, there is illustrated a method 110 for determining the location of a mobile wireless device 12 and a wireless environment. The method 110 can be performed by the system 8 described above, which may function according to the following basic steps.

The method 110 may comprise the step 112 of providing at least one mobile wireless distress transmitter, capable of transmitting a signal. In step 114, one or more fixed wireless distress transmitters in known locations are provided, each being capable of transmitting a signal. In function step 116, the signals are associated with vectors unique to the locations of each of the mobile and fixed wireless distress transmitters. In function step 118, the vector associated with the mobile distress transmitter signal is compared with the vectors associated with the fixed distress transmitter signals. In function step 120, the location of the mobile wireless distress transmitter is identified as the location of the fixed wireless distress transmitter transmitting a signal that is associated with a vector the most closely matches the vector associated with the signal transmitted by the mobile wireless distress transmitter.

The method 110 may further comprise the step of providing a plurality of repeaters for receiving and transmitting the transmitter signals, wherein each of the vectors has a magnitude and a distance, wherein the magnitude of each vector corresponds to the signal strength of each wireless distress transmitter at each of the repeaters and the distance corresponds to the distance of each wireless distress transmitter from each of the repeaters, and wherein the comparing step 118 compares the signal strength and the distance of the vector of the mobile wireless distress transmitter with the signal strength and the distance of the vectors of the fixed wireless distress transmitters and the identifying step 120 determines which vectors most closely match in terms of signal strength and distance.

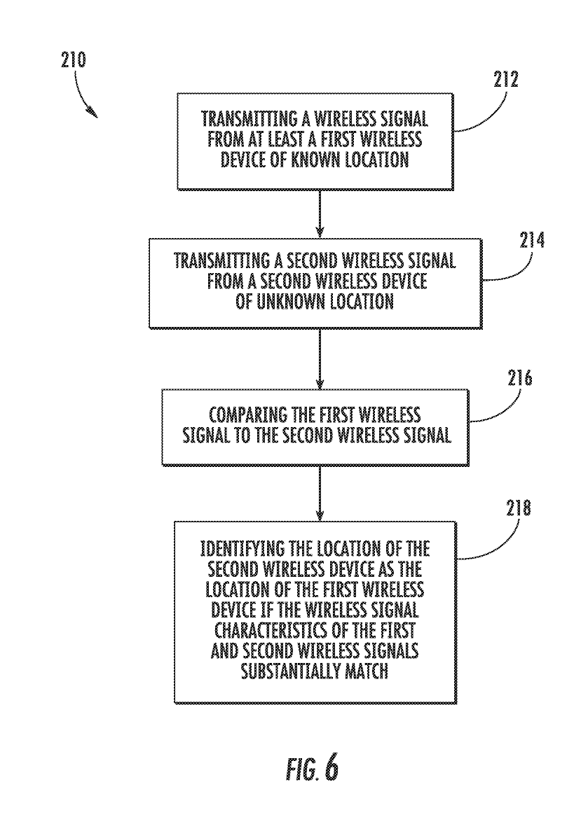

Another method 210, as shown in FIG. 6, may comprise the step 212 of transmitting a wireless signal from at least a first wireless device of known location, the wireless signal having a wireless signal characteristic unique to the origin of the signal of at least one wireless device. In function step 214, a second wireless signal may be transmitted from a second wireless device of unknown location, the second wireless signal having a wireless signal characteristic unique to the origin of the signal of the device. In function step 216, the first wireless signal is compared to the second wireless signal. In function step 218, the location of the second wireless device is identified as the location of the first wireless device if the wireless signal characteristics of the first and second wireless signals substantially match.

It should be appreciated that the first wireless device may be one of a plurality of fixed wireless devices each capable of transmitting a wireless signal unique to the origin of the signal of the fixed wireless device, and the second wireless device may be a mobile wireless device

It should be appreciated that the wireless signal characteristic of each wireless device may include a signal pattern that provides information about the location of the device. In such case, the comparing step 216 may further comprise the step of comparing the patterns of the mobile wireless device to the patterns of fixed wireless devices. Moreover, the wireless signal pattern of each wireless device may be represented by a vector corresponding to the origin of the corresponding wireless device, and the comparing step 216 may include the step of comparing the vectors represented by the signal pattern of each fixed wireless device with the vectors represented by the signal pattern of each mobile wireless device.

The method 210 may further comprise the step of providing one or more repeaters for receiving and relaying the wireless signals. In such case, the second transmitting step 214 may further comprise the functional step of activating the mobile wireless device to transmit the second wireless signal, which may be received by the one or more repeaters and relayed to a processing device, and wherein the identifying step 218 may include the step of locating the mobile wireless device closest to the fixed wireless device that transmits a signal represented by a vector that is closest in character to the vector represented by with the signal transmitted by the mobile wireless device.

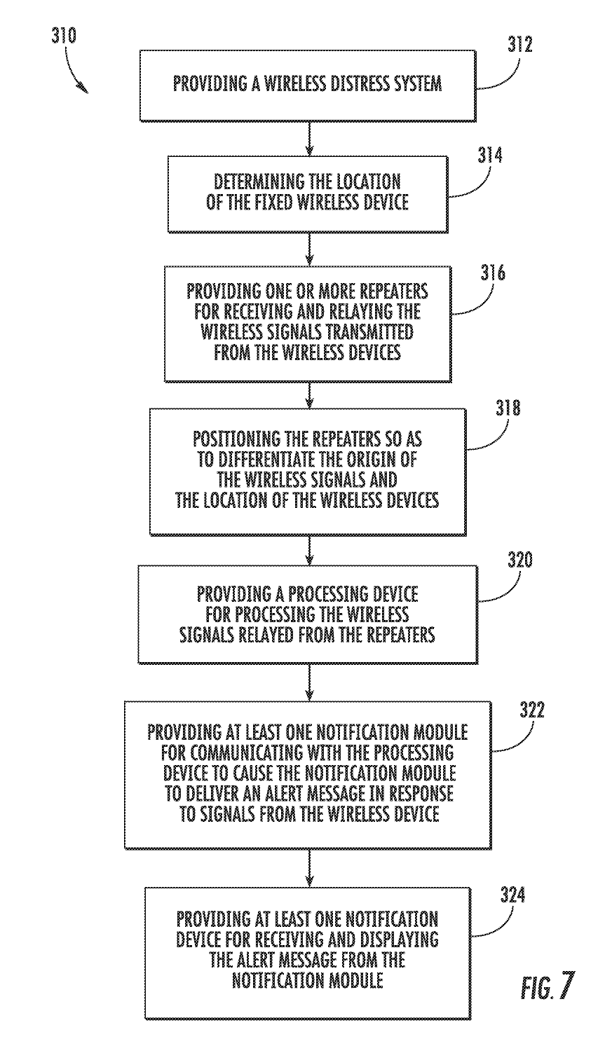

Another method 310, as shown FIG. 7, may comprise the step 312 of providing a wireless distress system with one or more wireless devices for transmitting wireless signals, the wireless devices including at least one fixed wireless device and at least one mobile wireless device, each wireless device having a wireless signal characteristic that provides information about the origin of the signal and the location of the device. In function step 314, the location of the fixed wireless devices is determined. In function step 316, one or more repeaters may be provided for receiving and relaying the wireless signals transmitted from the wireless devices. In function step 318, the repeaters may be positioned so as to differentiate the origin of the wireless signals and the location of the wireless devices. In function step 320, a processing device maybe provided for processing the wireless signals relayed from the repeaters. At least one notification module may be provided for communicating with the processing device to cause the notification module to deliver an alert message in response to signals from the wireless device, and depicted in function step 322. In function step 324, at least one notification device may be provided for receiving and displaying the alert message from the notification module.

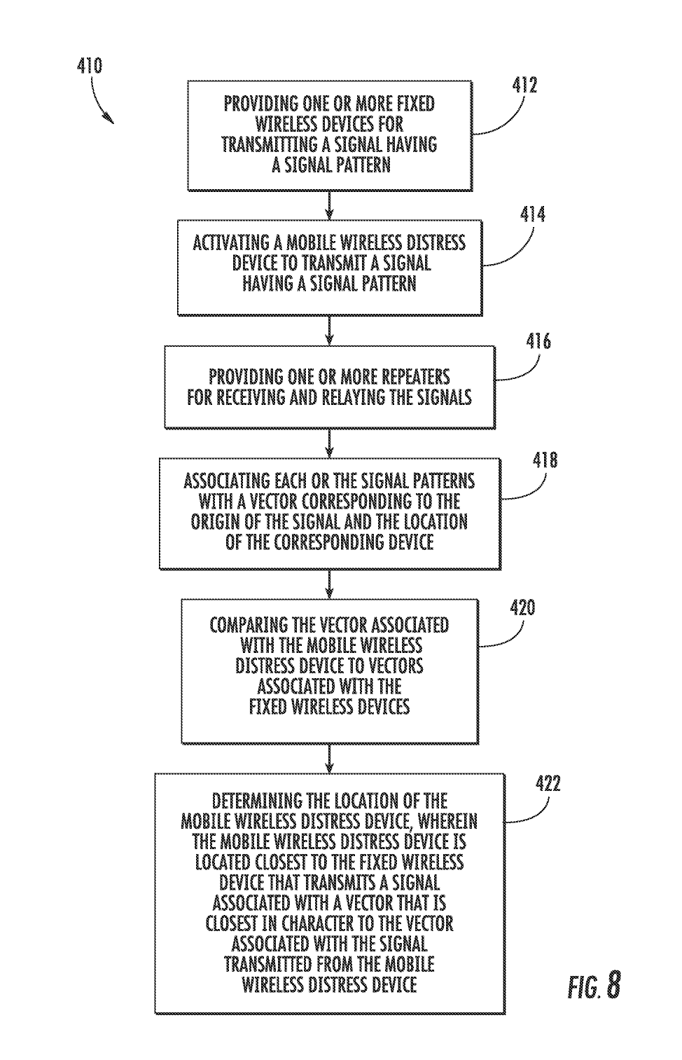

In yet another method 410, as shown FIG. 8, one or more fixed wireless devices may be provided for transmitting a signal having a signal pattern, as indicated in function step 412. In function step 414, a mobile wireless distress device may be activated to transmit a signal have a signal pattern. In function step 416, one or more repeaters may be provided for receiving and relaying the signals. In function step 418, each or the signal patterns may be associated with a vector corresponding to the origin of the signal and the location of the corresponding device. In function step 420, the vector associated with the mobile wireless distress device may be compared to vectors associated with the fixed wireless devices. In function step 422, the location of the mobile wireless distress device may be determined, wherein the mobile wireless distress device is located closest to the fixed wireless device 14 that transmits a signal associated with a vector that is closest in character to the vector associated with the signal transmitted from the mobile wireless distress device.

It should be appreciated that a method may comprise the step of processing an alert in response to the signal transmitted from the mobile wireless distress device.

Further, an exemplary method may comprising the steps of computing the magnitudes of the vectors by taking the square root of the sum of the squares of the signal strengths for each device at a corresponding repeater, determining the distance of each wireless device from each repeater by dividing the signal strength by the magnitude of each corresponding device, determining the difference in the distance of the mobile wireless distress device from each of the fixed wireless devices to determine the closest fixed wireless device to the mobile wireless distress device, and identifying by using the location of the mobile wireless distress device as the location of the fixed wireless device that is closest in distance to the mobile wireless distress device.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

What is claimed is:

1. A wireless distress system for identifying the location of a mobile wireless distress transmitter in a multi-dimensional environment, the system comprising:
a first wireless distress transmitter capable of transmitting a signal; and
a second wireless transmitter in a known location, capable of transmitting a signal unique to the location of the second wireless transmitter;
a processing device comparing the signal transmitted by the first wireless transmitter with the signal transmitted by the second wireless transmitter, and identifying the location of the first wireless transmitter as the known location of the second wireless transmitter if the signals substantially match.

2. A wireless distress system of claim 1, further comprising one or more notification devices and a notification module in communication with the processing device for delivering the alerts to at least one of the one or more notification devices in response to a signal transmission from the first wireless distress transmitter.

3. A wireless distress system of claim 1, wherein the processing device associates the signals of each of the transmitters with a vector, compares the vector associated with the signals transmitted by the first wireless transmitter with the vector associated with the signal transmitted by the second wireless transmitter, and identifies the location of the first wireless transmitter as the known location of the second wireless transmitter if the vector substantially match.

4. A wireless distress system of claim 1, wherein the first wireless distress transmitter is a mobile wireless distress transmitter and the second wireless distress transmitter is one of a plurality of fixed wireless distress transmitters in known locations, and wherein the processing device compares the signal transmitted by the mobile wireless distress transmitter with the signals transmitted by the fixed wireless distress transmitters, and identifies the location of the mobile wireless distress transmitter as the known location of the fixed wireless distress transmitter that transmits a signal that most closely matches the signal transmitted by the mobile wireless distress transmitter.

5. A wireless distress system of claim 4, wherein the processing device associates the signals of each of the transmitters with a vector, compares the vector associated with the signal transmitted by the mobile wireless distress transmitter with the vectors associated with the signals transmitted by the fixed wireless distress transmitters, and identifies the location of the mobile wireless distress transmitter as the known location of the fixed wireless distress transmitter transmitting a signal associated with a vector that most closely matches the vector associated with the signal transmitted by the mobile wireless distress transmitter.

6. A wireless distress system of claim 4, further comprising a plurality of repeaters for receiving the signals from the transmitters and relaying the signals to the processing device.

7. A wireless distress system of claim 6, wherein each of the vectors has a magnitude and a distance, wherein the magnitude of each vector corresponds to the signal strength of each wireless distress transmitter at each of the repeaters and the distance corresponds to the distance of each wireless distress transmitter from each of the repeaters, the processing device further being configured to compare the signal strength and the distance of the vector of the mobile wireless distress transmitter with the signal strength and the distance of the vectors of the fixed wireless distress transmitters to determine which vectors most closely match.

8. A wireless distress system for identifying the location of a wireless mobile distress transmitter, the system comprising:
at least one mobile wireless distress transmitter operable to transmit a signal unique to the origin of the signal and the location of the mobile wireless distress transmitter;
at least two spaced apart fixed wireless distress transmitters each located in a known location, and each being operable to transmit a signal unique to the origin of the signal and the location of each of the fixed wireless distress transmitters;
a plurality of repeaters operable to receive and relay the signals transmitted from the wireless distress transmitters; and
a processing device configured to receive the signals transmitted from the repeaters, associate each of the signals with a vector, compare the vectors associated with the signal transmitted by the mobile wireless distress transmitter with the vectors associated with the signals transmitted by the fixed wireless distress transmitters, and identify the location of the mobile wireless distress transmitter as the location of the fixed wireless distress transmitter transmitting a signal associated with a vector that most closely matches the vector associated with the signal transmitted by the mobile wireless distress transmitter.

9. A wireless distress system of claim 8, wherein each of the vectors has a magnitude and a distance, wherein the magnitude of each vector corresponds to the signal strength of each wireless distress transmitter at each of the repeaters and the distance corresponds to the distance of each wireless distress transmitter from each of the repeaters, the processing device further being configured to compare the signal strength and the distance of the vector of the mobile wireless distress transmitter with the signal strength and the distance of the vectors of the fixed wireless distress transmitters to determine which vectors most closely match.

10. A wireless distress system of claim 8, further comprising one or more notification devices and a notification module in communication with the processing device for delivering the alerts to at least one of the one or more notification devices in response to a signal transmission from the mobile wireless distress transmitter.

11. A method for identifying the location of a mobile distress transmitter in a three dimensional space, the method comprising the steps of:
a) providing at least one mobile wireless distress transmitter, capable of transmitting a signal;
b) providing one or more fixed wireless distress transmitters in known locations, each capable of transmitting a signal;
c) associating the signals with vectors unique to the locations of each of the mobile and fixed wireless distress transmitters;
e) comparing the vector associated with the mobile distress transmitter signal with the vectors associated with the fixed distress transmitter signals; and
f) identifying the location of the mobile wireless distress transmitter as the location of the fixed wireless distress transmitter transmitting a signal that is associated with a vector the most closely matches the vector associated with the signal transmitted by the mobile wireless distress transmitter.

12. The method of claim 11, further comprising the step of providing a plurality of repeaters for receiving and transmitting the transmitter signals, wherein each of the vectors has a magnitude and a distance, wherein the magnitude of each vector corresponds to the signal strength of each wireless distress transmitter at each of the repeaters and the distance corresponds to the distance of each wireless distress transmitter from each of the repeaters, and wherein the comparing step e) compares the signal strength and the distance of the vector of the mobile wireless distress transmitter with the signal strength and the distance of the vectors of the fixed wireless distress transmitters and the identifying step f) determines which vectors most closely match in terms of signal strength and distance.

13. A method for identifying the location of a mobile distress transmitter in a three dimensional space, the method comprising the steps of:
a) transmitting a wireless signal from at least a first wireless device of known location, the wireless signal having a wireless signal characteristic unique to the origin of the signal of the at least one wireless device;
b) transmitting a second wireless signal from a second wireless device of unknown location, the second wireless signal having a wireless signal characteristic unique to the origin of the signal of the device;
c) comparing the first wireless signal to the second wireless signal; and
d) identifying the location of the second wireless device as the location of the first wireless device if the wireless signal characteristics of the first and second wireless signals substantially match. 118

14. The method of claim 13, wherein the first wireless device is one of a plurality of fixed wireless devices each capable of transmitting a wireless signal unique to the origin of the signal of the fixed wireless device, and the second wireless device is a mobile wireless device

15. The method of claim 14, wherein the wireless signal characteristic of each wireless device includes a signal pattern that provides information about the location of the device, and the comparing step c) further comprises the step of comparing the patterns of the mobile wireless device to the patterns of fixed wireless devices.

16. The method of claim 15, wherein the wireless signal pattern of each wireless device is represented by a vector correspond to the origin of the corresponding wireless device, and the comparing step c) includes the step of comparing the vectors represented by the signal pattern of each fixed wireless device with the vectors represented by the signal pattern of each mobile wireless device.

17. The method of claim 16, further comprises the step of providing one or more repeaters for receiving and relaying the wireless signals.

18. The method of claim 17, wherein the second transmitting step b) further comprises the step of activating the mobile wireless device to transmit the second wireless signal, which is received by the one or more repeaters and relayed to a processing device, and wherein the identifying step d) includes the step of locating the mobile wireless device closest to the fixed wireless device that transmits a signal represented by a vector that is closest in character to the vector represented by with the signal transmitted by the mobile wireless device.

19. A method for identifying the location of a mobile distress transmitter in a three dimensional space, the method comprising the steps of:
a) providing a wireless distress system with one or more wireless devices for transmitting wireless signals, the wireless devices including at least one fixed wireless device and at least one mobile wireless device, each wireless device having a wireless signal characteristic that provides information about the origin of the signal and the location of the device;
b) determining the location of the fixed wireless devices;
c) providing one or more repeaters for receiving and relaying the wireless signals transmitted from the wireless devices;
d) positioning the repeaters so as to differentiate the origin of the wireless signals and the location of the wireless devices;
e) providing a processing device for processing the wireless signals relayed from the repeaters;
f) providing at least one notification module communicating with the processing device to cause the notification module to deliver an alert message in response to signals from the wireless device; and
g) providing at least one notification device for receiving and displaying the alert message from the notification module.

20. A method for identifying the location of a mobile distress transmitter in a three dimensional space, the method comprising the steps of:
a) providing one or more fixed wireless device for transmitting a signal have a signal pattern;
b) activating a mobile wireless distress device to transmit a signal having a signal pattern;
c) providing one or more repeaters for receiving and relaying the signals;
d) associating each or the signal patterns with a vector corresponding to the origin of the signal and the location of the corresponding device;
e) comparing the vector associated with the mobile wireless distress device to vectors associated with the fixed wireless devices; and
f) determining the location of the mobile wireless distress device, wherein the mobile wireless distress device is located closest to the fixed wireless device 14 that transmits a signal associated with a vector that is closest in character to the vector associated with the signal transmitted from the mobile wireless distress device.

21. The method of claim 20, further comprising the step of processing an alert in response to the signal transmitted from the mobile wireless distress device.

22. The method of claim 20, further comprising the step of:
a) computing the magnitudes of the vectors by taking the square root of the sum of the squares of the signal strengths for each device at a corresponding repeater;
b) determining the distance of each wireless device from each repeater by dividing the signal strength by the magnitude of each corresponding device;
c) determining the difference in the distance of the mobile wireless distress device from each of the fixed wireless devices to determine the closest fixed wireless device to the mobile wireless distress device; and
d) identifying by using the location of the mobile wireless distress device as the location of the fixed wireless device that is closest in distance to the mobile wireless distress device.
